(19) United States
(12) Patent Application Publication
(10) Pub. No.: US 2015/0089435 A1
(43) Pub. Date: Mar. 26, 2015

(54) SYSTEM AND METHOD FOR PREDICTION AND RECOGNITION OF INPUT SEQUENCES

(71) Applicant: MICROTH, INC., Staten Island, NY (US)

(72) Inventor: Yevgeniy Kuzmin, Celebration, FL (US)

(21) Appl. No.: 14/490,955

(22) Filed: Sep. 19, 2014

Related U.S. Application Data
(60) Provisional application No. 61/882,408, filed on Sep. 25, 2013.

(51) Int. Cl. G06N 5/04; G06F 3/0484; G06F 3/0488

(52) U.S. Cl. CPC G06N 5/048; G06F 3/0488; G06F 3/04842
USPC 715/773

(57) ABSTRACT

A method/system may construct an expectation tree based upon an input flow, the expectation tree having a root node, nodes, each path from a root node to a node representing a potential input sequence from the input flow, each node including a counter for a number of occurrences of the respective potential input sequence. The method/system may construct touch distribution functions representing a weighted sum of prior touch prints for the targets, determine expectation weights of the potential input sequences and based upon expectations of pairs of sequences in the expectation tree, determine touch weights of potential input sequences toward a sequence of input touch prints and based upon the touch distribution functions, build an ordered list of input candidate sequences, and display the ordered list to the user for selection and confirmation of a desired input candidate sequence.

### RELATED APPLICATION

This application is based upon prior filed co-pending application Ser. No. 61/882,408 filed Sep. 25, 2013, the entire subject matter of which is incorporated herein by reference in its entirety.

### TECHNICAL FIELD

The present disclosure relates generally to methods and systems for improved combined prediction and recognition of input sequences for electronic devices and, more particularly, for precognition of input sequences based on analysis of spatial and linguistic statistical information about user input history.

### BACKGROUND

With the development of mobile devices, different touch interfaces become one of the main methods of computer-human interaction. Typical touch user interfaces are usually based on selection of a sequence of several on-screen target objects. This selection is based on positional information about touch input represented by sequences of individual touches or gestures near target positions. The screen target objects closest to positions of touches or a gesture are selected for further processing. One of the typical exemplars of such touch interfaces is the virtual keyboard with touch targets represented by keys with symbols on them.

Limited screen area of mobile and wearable devices quite often doesn't provide enough space for a virtual keyboard with convenient large buttons, so operating the device with miniature keys may lead to ambiguity of input, and therefore to wrong recognition of targets and input errors. Accordingly, methods and systems are desired to provide improved input recognition for a broad range of electronic devices, applications and languages.

One of the approaches to improve input quality and speed is to predict the future input, i.e. to present to a user a set of words based on language statistics and previous input history. Often, prediction words are not balanced, and existing prediction systems either “under-predict” further input for frequent words, like “I” or “the”, or “over-predict” the input for words with many suffix variants. Input prediction of words only is an artificial limitation, and flexible, non word-based prediction of future input sequences of optimal and variable length is desirable.

Data structures of existing prediction systems store a huge amount of words and word combinations. Existing prediction systems may store a number of quite rare word pairs, but lack of frequent combinations of several, more then two, words. There is a need for a compact, self-balancing data structure that can store input expectations of sequences and adapt to input history.

The improved recognition and prediction system should combine positional information about user touch input sequences and information about previous user input and language statistics. Existing approaches don't solve the above-described problems in full. Therefore, advanced methods for improved target recognition and prediction for touch input interfaces based on user input history are desirable.

Quite often, input recognition and prediction systems are separated. There is a desire for an input precognition system uniformly combining recognition and prediction into one common precognition workflow.

### SUMMARY

In view of the foregoing background, it is therefore an object of the present disclosure to provide systems and methods for precognition of input sequences based on analysis of spatial and linguistic statistical information about user input history.

This and other objects, features, and advantages in accordance with the present disclosure are provided by a system of input sequence prediction and recognition comprising an input component configured to register touch prints representing an input interaction between input surface and input object for selection of input values, associated with a plurality of input targets, and a processor coupled to the input component. The processor may be configured to construct an expectation tree based upon an input flow, the expectation tree comprising a root node, a plurality of nodes. Each path from a root node to a node represents a potential input sequence from the input flow, and each node comprises a counter for a number of occurrences of the respective potential input sequence. The processor may be configured to construct touch distribution functions representing a weighted sum of prior touch prints for the plurality of targets, and determine expectation weights of the potential input sequences and based upon expectations of pairs of sequences in the expectation tree. The processor may be configured to touch weights of potential input sequences toward a sequence of input touch prints and based upon the touch distribution functions, build an ordered list of input candidate sequences, the order being based upon their combined weight, wherein combined weight is a product of expectation and touch weights, and display the ordered list to the user for selection and confirmation of a desired input candidate sequence.

Additionally, the input interaction may comprise a plurality of touch taps of input targets at the input surface, corresponding to the input sequence. The input interaction may comprise a continuous input trace connecting input targets at the input surface, corresponding to the input sequence. The processor may be configured to recognize partial traces between consecutive targets for input target recognition. The processor may be configured to recognize positions of sharp directional turns of the continuous input trace at the input surface as positions of touch input interaction.

Also, the processor may be configured to add accepted input candidate sequences from the input flow to the expectation tree by adding a new leaf node and respective path to the expectation tree. The processor may be configured to add consecutive, non-overlapping accepted candidate sequences from the input flow to the expectation tree. The processor may be configured to add accepted candidate sequences starting at every input value from the input flow to the expectation tree. The expectation weight of a respective potential input sequence may be a value measuring a number of potentially saved inputs if a predicted sequence is correct.

The expectation weight of the respective potential input sequence may be a product of maximal expectation of the respective potential input sequence after all possible previous sequences in a current input flow and a length of the respective potential input sequence. The touch weight of the respective potential input sequence may comprise a value measuring a spatial proximity of an input trace and expected input trace for the respective potential input sequence. The touch weight of the respective potential input sequence may be a product of touch weights of input targets corresponding to inputs of the input sequence, and the touch weight of a target may be an integral of the product of touch print and target distribution function.

In some embodiments, the input candidate sequences may be word aligned and comprise at least one word. The input candidate sequences may comprise sequences of input values of an arbitrary length. The input candidate sequences may be limited to one letter, and the plurality of input targets may have a common centered distribution function. The input precognition may be determined by cells of a functional Voronoi diagram for target distribution functions, weighted by expectation weights of inputs, assigned to the plurality of input targets.

A default candidate sequence may comprise a candidate sequence with a greatest combined weight, and may be displayed in an input field of an application, and the user may confirm input of any part of the default candidate sequence. The processor may be configured to detect and correct misprinted candidate sequences upon user request. The processor may be configured to expand a predicted sequence inductively, using a predicted sequence for prediction of a new sequence at a subsequent stage. The processor may be configured to use the expectation tree for data compression with prediction of the input flow for storing of input history between sessions and transmission to another system.

The plurality of input targets may comprise regions of arbitrary shape at the input surface. For example, the plurality of input targets may comprise keys of a keyboard. The plurality of input targets may comprise objects of a 2-dimensional input interface. The plurality of input targets may comprise objects of 1-dimensional input interface.

Another aspect is directed to a method of input sequence prediction and recognition. The method may include operating an input component to register touch prints representing an input interaction between input surface and input object for selection of input values, associated with a plurality of input targets, and operating a processor coupled to the input component. The processor may construct an expectation tree based upon an input flow, the expectation tree comprising a root node, a plurality of nodes. Each path from a root node to a node represents a potential input sequence from the input flow, and each node comprises a counter for a number of occurrences of the respective potential input sequence. The processor may construct touch distribution functions representing a weighted sum of prior touch prints for the plurality of targets, and determine expectation weights of the potential input sequences and based upon expectations of pairs of sequences in the expectation tree. The processor may determine touch weights of potential input sequences toward a sequence of input touch prints and based upon the touch distribution functions, build an ordered list of input candidate sequences, the order being based upon their combined weight, wherein combined weight is a product of expectation and touch weights, and display the ordered list to the user for selection and confirmation of a desired input candidate sequence.

### BRIEF DESCRIPTION OF THE DRAWINGS

FIGS. 1a-1d are schematic diagrams illustrating the process of construction of the expectation tree, according to the present invention.

FIG. 2 is a diagram illustrating a part of the static expectation tree, according to the present invention.

FIG. 3 is a diagram illustrating tap input precognition process, according to the present invention.

FIG. 4 is a flowchart illustrating the workflow of the process of input precognition, according to the present invention.

FIG. 5a is a schematic diagram of the Voronoi diagram of a set of points representing centers of buttons of a part of virtual keyboard, according to the present invention;

FIG. 5b is a schematic diagram of the weighted Voronoi diagram of a set of letters of a part of virtual keyboard with weights equal to letter frequencies, according to the present invention.

FIG. 6 is a schematic diagram illustrating the process of input precognition of weighted Voronoi diagram for the selection of one-dimensional targets, according to the present invention.

FIG. 7 is a diagram illustrating the process of combining of input sequences for continuous input, according to the present invention.

FIG. 8 is a diagram illustrating precognition of partial traces for continuous input, according to the present invention.

FIG. 9 is a diagram illustrating continuous input traces with surface clicks, according to the present invention.

FIG. 10a is a diagram illustrating 1-dimensional interface utilizing continuous input traces with surface clicks, according to the present invention.

FIG. 10b is a diagram illustrating an example of one-dimensional circular interface of the invention utilizing continuous traces with surface clicks for selection of targets.

FIG. 11 is a schematic diagram of a system, according to the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The method/system of the invention is based on an approach to combined recognition and prediction of input sequences of arbitrary length, based on processing of the history of input, represented by a self-balanced expectation tree of user input history, and spatial information about user touches, represented by functions of spatial distribution.

### Input Expectation

There are many different approaches to input prediction. In general, most of them are based on storage of input expectations—conditional probabilities of different sequential combinations of pairs of input sequences. Prediction systems usually store information about expectations as ratios of how many times one input sequence appeared after another input sequence in the input history or a large language corpus, Due the huge number of possible combinations of input sequences, the amount of memory to store all possible combination may be enormous. For example, the number of all possible combinations of 3-letters sequences after 3-letters sequences is more then 300 million.

Most of these combinations never occur in a real language and some may occur very rarely, but existing prediction approaches need to store them because they may occur again in the future. It is the main problem of any prediction method what sequences and combination of sequences to store. To reduce the number of stored combinations, existing prediction systems may either store only a limited number of most frequent combinations, or limit a length of stored input sequences, or store only combinations composing words or word pairs. All these limitations are artificial and lead to non-optimal prediction.

Expectations may be determined by statistical analysis of user input history and also some external sources. For example, initial values of expectations may be determined by statistical analysis of a large text corpus of some language, and are later updated by processing of user input history.

The information about expectations may be stored as tables of combination frequencies, or word frequency dictionaries, or dictionaries of word sequences. Some of prediction systems may store expectation as multidimensional arrays. In this case, the method/system may store expectations of all possible pairs of input sequences after other input sequences of some given length or structure. For example, the method/system may store expectations of a third letter after the first two letters. To determine expectation of different inputs, the method/system stores two previous inputs, and expectations corresponding to these two previous inputs for all possible future inputs. To reduce the storage space, multidimensional arrays may be stored as hash tables.

Word frequency dictionaries may be used for auto-completion—prediction of ending sequences of words after input of several first letters of a word. Dictionaries of sequential words may be used to predict words after the previously entered word. Most of existing prediction systems are word aligned. Due to all these limitations, most of existing prediction systems are unbalanced, require a lot of memory, and don't provide optimal prediction.

The beneficial property of the prediction method/system of the invention is that it is not word aligned. It predicts future input sequences of any arbitrary length. It may be a few letters, a part of a word, a word or even several words and their parts. The length of a predicted sequence is determined by the entire history of input before the prediction. The method/system of the invention uses a new dynamic data structure to store expectations of combination of input sequences of arbitrary length: the expectation tree.

### Expectation Trees

The expectation tree of the invention stores expectations for all essential input sequences and their combinations of different length. The expectation tree is a dynamic structure growing during the process of input to include new sequences and combinations and to change their expectations. Any input flow or text may be converted into the expectation tree.

Each node of expectation tree stores an input value and has a counter of a number of occurrences of the input sequence composed from all input values at the path from the root to this node of the expectation tree. The root's counter is the number of all possible input sequences in the expectation tree.

To avoid memory problems and misbalancing of other prediction methods, the method/system of the invention stores only essential input sequences. The input sequence is essential, if the path in the expectation tree corresponding to it contains one and only one new leaf node. The algorithm of construction of the expectation tree of the invention from the data stream is the following: at each step of the process, the method/system of the invention traces the path from the root to a new leaf node corresponding to the current essential input sequence. The algorithm adds a new leaf node to the expectation tree. The new node contains the last input value of the essential sequence as a node value. The counter of the new node is set to 1. Counters of all internal nodes along the path are incremented by 1.

The algorithm of construction of the expectation tree resembles the LZW algorithm for data compression. Differently to LZW approach, the method/system of the invention may add input sequences starting at any position of the input flow. This method/system also stores the number of occurrences of each node, and increments this number for all nodes belonging to each new added sequence.

Depending on available memory and other requirements, the method/system of the invention may use different strategies of adding essential sequences. In one embodiment, the method/system may add essential sequences starting at each input of the input flow. In this case, the expectation tree grows very fast and provides better prediction at earlier stages. In another embodiment, method/system may add non-intersecting consecutive essential sequence. In this case, the method/system minimizes memory consumption. In another embodiment, the method/system may add word-aligned sequences.

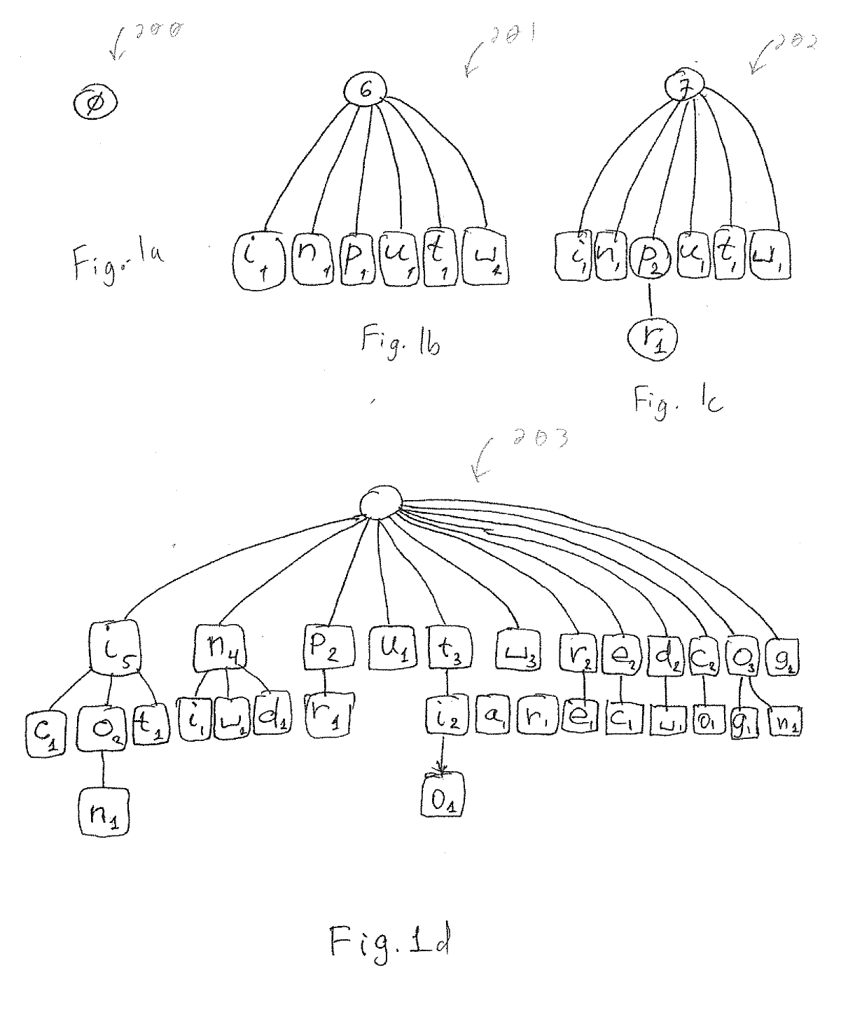

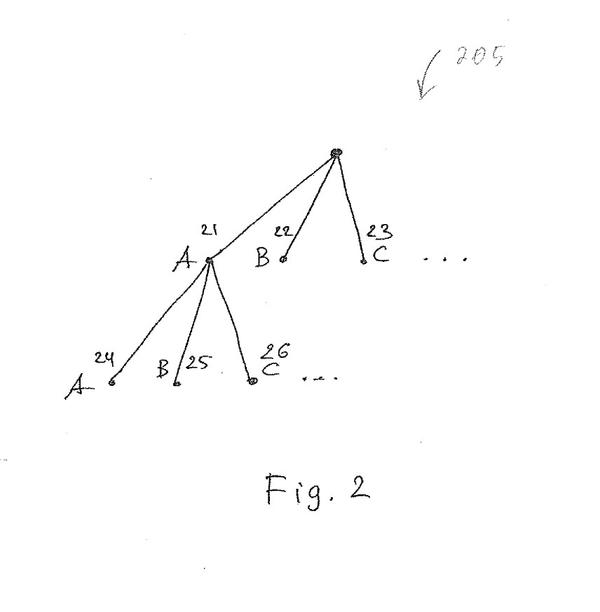

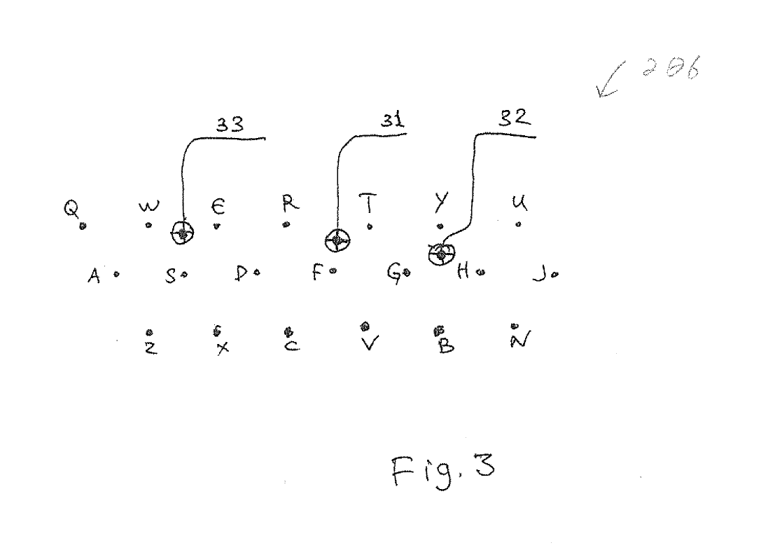

FIGS. 1a-1d includes diagrams 200-203, which show the process of construction of the expectation tree for the input stream “input prediction and recognition”. At the beginning of the process, the expectation tree is empty, and the counter in the root node is equal 0 (FIG. 1a). In the next steps, input sequences containing only 1 input are added (FIG. 1b). At the step shown in FIG. 1c, the sequence “pr”, containing 2 inputs is added to the expectation tree.

The method/system continues construction of the expectation tree, adding a new input sequence from the root to leaf node at each step along the path determined by input sequence. It also increments the counter in all the nodes of the path. FIG. 1d shows the final expectation tree for the entire input stream, containing all inputs. This example shows that the expectation tree grows faster for frequent sequences and letters like “i”, “n”, “t”. Longest sequences “ion” and “tio” in the expectation tree at FIG. 1d are parts of the sequence “tion”, which occurs twice in the original stream.

Each node P of the expectation tree corresponds to some input sequence from the root R to the node P. A beneficial property of the expectation tree of the invention is that the ratio of the counter of a node to the counter of the root C(P)/C(R) is approximately equal to the probability of occurrence of the input sequence corresponding to node P in the input stream. This approximation improves with growth of the expectation tree.

Another beneficial property of the expectation tree of the invention is that it provides calculation of expectation of one sequence after another. The path P from the root of the tree to a node may correspond to the first input sequence. The path F from a node P to another node F may correspond to a second input sequence. Then, the expectation of the second input sequence F after the first input sequence P is approximately equal to the ratio of numbers of occurrences in the last nodes of these sequences in a combined path in the expectation tree.

Therefore, to calculate the expectation of the sequence F after sequence P, the method/system firstly traces the path in the expectation tree from the root, corresponding the sequence P, and checks the value of the counter in the last node C(P). At the next stage, the method/system continues the path in the expectation tree from this last node, corresponding to the sequence F and checks the value of the counter in the last node C(F). The expectation of F after P is approximately equal to C(F)/C(P). If the combined path (P+F) doesn't exist in the expectation tree, the method/system may consider the expectation of this combination as 0.

For example, for the expectation tree at FIG. 1d, the expectation of sequence F=“io”, after P=“t” is equal to ⅓. In the case of empty first sequence P, the ratio represents a number of occurrences of a future sequence F in the entire input flow. Therefore, the method/system of the invention may use the expectation tree to calculate expectation of different combinations of sequences. Values of expectations become more and more accurate while the expectation tree grows.

Due to the similarity of LZW and the expectation trees, the expectation trees of the invention may store the entire history of input stream in a compressed representation. The method/system of input prediction of the invention uses the entire input history for determination of expectation, but not some limited fragments of the history, as in other methods. This improves accuracy of the method/system of prediction of the invention, comparing to other prediction approaches.

Yet another beneficial property of the expectation tree of the invention is that it is self-balancing. The method/system adds new essential input sequences based on entire input stream content. So, if some combinations are more frequent, then the expectation tree will contain more continuations for these frequent sequences and improve prediction for frequent sequences. From other side, parts of the expectation trees, corresponding to rare sequences will be small, reducing memory requirements. Differently to existing prediction approaches with complex storage decision algorithms, the prediction method/system of the invention provides a simple and self-balanced approach to selection of stored input sequences and their combinations. Therefore, there is no need for sophisticated decision algorithms. The expectation tree of the invention is self-balancing by the construction thereof.

Another beneficial property of expectation trees of the invention is that they are language-independent. The method/system may either construct separate expectation trees for different input languages, or one common expectation tree for several languages. Expectation trees may be based on user input entirely and include only sequences entered by user. Also expectation trees may be application-based, and include sequences entered in some specific application.

The method/system of the invention may use different approaches for storage of the expectation tree. Between input sessions, the method/system may store only input values of nodes and recursively restore values of node counters before use. In one embodiment, the method/system also may use static expectation trees for prediction without adding new essential sequences and updating of the counters. In this case, node counters may represent expectations of child nodes after parent nodes.

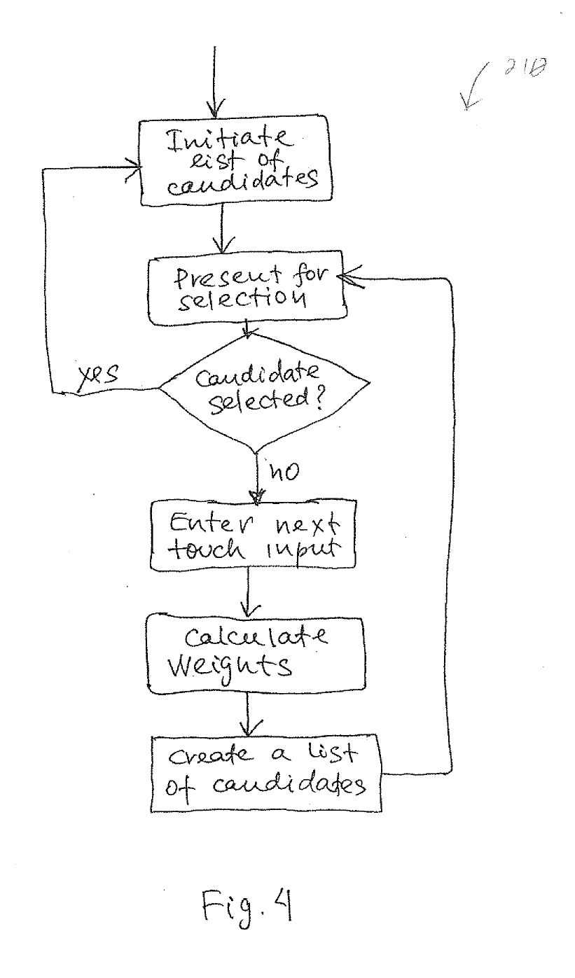

FIG. 2 includes a diagram 205, which shows a part of such static expectation tree. Nodes of the first level 21, 22, 23 correspond to input events of letters A, B, C without history. Expectations of letters are equal to 8.2%, 1.5%, and 2.8% correspondingly. Nodes of the second level 24, 25, 26 correspond to input events of letters A, B, C after the known input of letter A. For example, the expectation of the event 24 after the event 21 (input of “A” after “A”) is equal 0.004%, and expectation of the event 25 after the event 21 (input of “B” after “A”) is equal 0.63%.

### Expectation Weight

The method/system of the invention may determine expectations of different possible combinations of input sequences. For any given input history flow, the method/system may calculate expectations of all possible future sequences after it. To determine the possible sequences F and their expectations, the method/system may consider subtrees of the expectation tree after all possible history sequences P.

The number of possible future sequences may be large, but the number of candidate sequences, which will be presented to a user for selection, should be small. So, the prediction method/system of the invention has to select just a few optimal candidate sequences.

Existing prediction systems usually display a list of words, containing a limited number of candidate words ordered by their frequency, independently on their length and number of similar words. That may lead to non-optimal predictions of frequent words and words having a variety of endings or suffixes.

The method/system of the invention may use a completely different algorithm for selection and ordering of candidate sequences. For each candidate sequence from subtrees after history sequences, the method/system of the invention may calculate the expectation weight of a sequence.

The expectation weight of a sequence is a function of expectation and the length of a sequence, which represents a number (amount/quantity) of user inputs, which may be potentially saved by the prediction system, if the predicted sequence is correct. In one embodiment of the disclosure, the expectation weight may be equal to a product of the expectation of the candidate sequence and the length of a candidate sequence. These candidate sequences may be parts of words, whole words, and even sequences of words.

The prediction method/system of the disclosure may order candidate sequences by their expectation weights and to display a few first candidate sequences. The candidate sequence with the greatest expectation weight may be considered as a default candidate and entered after a confirmation, or the user may select another of the displayed candidate sequences. If the desired input sequence is not displayed, then user may browse a list of other candidate sequences, or just continue the input process without prediction.

Based on input history and language statistics, the method/system of the invention may predict long standard word sequences, like names, language forms, phrases, etc., even including spaces, and punctuation signs. For example, the method/system may predict standard phrases like: “see you later”, “how are you doing”, based on input of a few initial letters.

Another beneficial property of the prediction method/system of the invention is that it is more optimal for languages with flexible word forms. In many languages, like German, Finnish or Russian, words may have several genders, cases, and forms with the common root. For example, the word “ [symbol] ” ( [symbol] red [symbol] in Russian) may have single and plural forms, 3 genders and 7 cases. Totally, there are 13 different variants of this word with the common root [symbol] . Existing prediction systems usually predict only one of these whole word forms and require input of the whole root before prediction of a suffix, but the method/system of the invention may predict the common root by a few letters, for example [symbol] , and proceed immediately to prediction of a suffix.

Therefore, the method/system of the invention provides an optimal prediction of input sequences, based on entire input history and processing of the expectation tree. The method/system of the invention may further combine input prediction and recognition processes in one common flow: from one side, after each recognized input event, the method/system of invention may generate a new list of prediction candidate sequences, and from another side, the method/system uses expectation tree to improve input recognition.

### Inductive Prediction

The method/system of the invention may also inductively predict expected future sequences based on already predicted sequences. To do this, the method/system may predict the next sequence in a proposition where the previous predicted sequence was a correct sequence. This prediction may be based on the procedure described hereinabove. The method/system may temporarily add the first predicted sequence into the expectation tree and recalculate the next optimal sequence for this tree.

The step of induction may be repeated as many times as needed, so the method/system of the invention may build an expected sequence of unlimited length. Also, the method/system may construct inductive sequences for other less expected sequences, and therefore have a list of inductive expected sequences.

Inductive prediction is the unique feature of the method/system of the invention, comparing to other prediction approaches. It provides a prediction of a sequence of any length, which could include many words. The user interface of the method/system may display a part of the default expected sequence and a user may accept any part of this predicted sequence by selection of the last symbol of the desired part. After this selection, the method/system may add the selected sequence to the expectation tree permanently and update the expected sequence. If the method/system displays a wrong sequence, then a user may continue to input next symbols, and the method/system will recognize them and generate new expected sequences.

In one embodiment of the system, inductive prediction may be limited by only one step. In another embodiment, the length of each inductively predicted sequence may be limited, for example, to no more then 2 symbols, or even 1 symbol.

### Input Recognition

The prediction method/system of the invention may be used with any input method. In one embodiment, the method/system may process a non-ambiguous input stream, but the prediction method/system of the disclosure is especially beneficial for ambiguous input, like mobile touch input.

As it was mentioned before, due small sizes of screens, the touch input for mobile devices is often ambiguous, and a touch may correspond to a number of different possible input values. The input method/system of the invention may recognize the correct input sequence in interaction with user. The beneficial feature of the method/system of the invention is that it may combine input prediction with the recognition of ambiguous input into one common framework. The method/system of the invention may use the expectation tree, not only for the prediction of future input sequences, but also for the recognition of current ambiguous input sequences.

Touch input recognition is mainly based on analysis of spatial interposition of touch traces toward input targets corresponding to input values of a sequence. Input sequences with input targets, which are more close to input touch traces, may be considered as preferred candidates. The method/system of the invention may work with any approach to touch input. The input recognition method/system of the invention may store information about spatial properties of touch interactions during the input. The beneficial property of the method/system of the invention is that it may combine both spatial and contextual recognition of ambiguous input sequences into the common process, which further will be called precognition.

### Touch Input

Touch input interfaces of the disclosure may be represented by a set of input targets at the input surface. A user interaction with the input surface may be represented by a sequence of touches, flicks, strokes, or gestures by an input object of an input surface selecting input targets. The method/system recognizes selected input targets using spatial information about the touch prints and statistical information about previous inputs.

The input surface may be any surface registering user interaction with it during the input. In one embodiment, the input surface may be a 2-dimensional discrete raster surface of any shape with coordinate system over it. For example, it may be a flat rectangle with discrete orthogonal coordinate system (x,y). In another embodiment, the input surface may be 1-dimensional curve of any shape with coordinate system (d) along the curve. For example, it may be a circle, a circular segment, straight-line segment, or a polygonal combination of segments.

The touch interaction may have any nature. In one embodiment, it is a physical touch of an input object to touch-sensitive panel or screen. In other embodiments, the interaction may be represented by the image of input object over the input surface (over screen) of input object over the projection of input surface.

The method/system of the invention may use any type of touch or contact interaction between input surface and input object for input. The method/system may register mechanical, electric, electronic, electromechanical, magnetic, optical, acoustic, proximity, light, and any other interactions. The input object may comprise at least one of: a sensor, a camera, a stylus, a pen, a wand, a laser pointer, a cursor, a ring, a bracelet, a glass, an accessory, a tool, a phone, a watch, an input device, a toy, an article of clothing, a finger, a hand, a thumb, an eye, an iris, a part of human body, a joystick, and a computer mouse.

### Input Targets

Input targets of the invention may be represented by regions at the input surface. Input targets may have any arbitrary shape. In one embodiment, input targets may be dots. In another embodiment, input targets may be regions of any arbitrary shapes. In yet another embodiment, input targets may be icons, representing applications, documents and functions. In yet another embodiment, input targets may be glyphs, representing input values.

Input targets have input values associated with them. The input values may comprise at least one of: letters of an alphabet, symbols, numbers, syllables, ideographic characters, script elements, words, passwords, stems, strings, macros, control actions, tasks, operations, states, functions, applications, decisions, outcomes and any other values from a list of indexed values. Input values assigned to input targets may be unambiguous, like for a regular computer keyboard, or several values may be assigned to one input target, like for on-screen phone keypad.

In one embodiment of the invention, most input targets may have the same or near the same shape. For example, in the embodiment of a virtual keyboard, input targets for letters and symbols may be rectangular boxes or circles of the same size. Input targets also may comprise letters of near the same size.

Input targets of the invention may have origins, associated with them. The origin O is the position (x,y) at the input surface. In one embodiment, the origin of an input target may coincide with the center of the input target shape. For example, in one of the keyboard embodiments, input targets may be circles or rectangles with letters encircled within them with origins in the centers of targets.

In another embodiment, input targets may be represented by shapes only, without any specific origin. For example, elongated box may represent the shape input target for SPACE, or other control inputs.

### Touch Prints

In one embodiment, the method/system of the invention may use clicks or taps on the input surface for selecting of input targets. To enter the input value, which is associated with input target, the user may touch the input surface near the input target. The method/system registers a touch print of each touch during the user's interaction with input surface. The touch print represents the spatial information about a touch input. The touch print may be described by a touch print function P(x,y). Depending on implementation of touch sensors and detection algorithms, the touch print function may have different types.

In one embodiment of the invention, the touch print may be represented by a dot in position (x,y). In this embodiment, the touch print function P(x,y) is equal 1 in the position of the touch, and 0 in all other position. This representation, based on center position of the touch print, is the common and simple way of registering and describing of information about touches. This type of touch prints is well suited for input objects having a small contact area with the input surface, for example, pen, stylus, or nails.

The above described dot touch print embodiment is less suited for input object having a larger contact area, so in another embodiment of the system, the touch print may have an arbitrary shape: circle, oval, rectangle, some irregular spot, etc. In this embodiment, the touch print function P(x,y) may be equal to 1 in all position within the touch shape, and to 0 in all other position outside the touch shape. For example, many touch sensors provide information about the center of touch and an approximated radius of the touch print. In this case, the touch print function is equal to 1 within a touch circle, and equal to 0 outside. In one embodiment of the system, if the shape of all touch prints are the same, then the touch prints may be represented just by their centers and the shape of touch print.

In yet another embodiment, the touch print function P(x,y) may have values in the range from 0 to 1. This function may describe different characteristic of a touch, for example, this value may represent a possibility that a specific position (x,y) was touched during a touch input. For example, advanced touch detectors may provide pressure information in each position of a touch print, and the value P(x,y) may be a scaled value of pressure of touch object to the touch surface in this position.

In one embodiment of the system, touch print functions may be the same for all touches. In this case, touch prints may be represented just by their centers and the touch print function.

The method/system may also use artificial touch print functions, approximating real touch print functions. For example, the method/system may collect statistical information about user touch prints and construct a generic function P(W), depending on width of user finger W. Further, the user may set the value W accordingly to individual needs, and the method/system may generate center based touch prints P(x,y) around the center point (x,y).

Therefore, the method/system of the invention may use any function representing interaction between the input surface and the input object for representation of touch prints. In many embodiments, the touch print may be represented by the center point and some additional scalar information, describing the shape of the touch print. Such touch prints are called centered touch prints.

In one embodiment, the touch print may be represented by a raster discrete touch print functions P(x,y), where x,y are coordinates of pixels at discrete input surface. In yet another embodiment, the touch print may be represented by a path of the input object over the input surface.

### Target Distribution Functions

The method/system of the invention may collect statistical information about the process of how the user selects input targets. For each target T, the method/system may collect information about all touch prints that a user made to select this target T. Based upon information on all touch prints, which user made for selection of a specific input target T, the method/system may construct a touch spatial distribution function F(T,x,y) for this target T.

The touch distribution function F(T,x,y) for an input target T is the weighted sum of all touch prints functions P(x,y) for all touches selecting the input value associated with target T. F(T,x,y)=SUM(P(x,y))/N(T), where N(T) is the number of touch prints collected for the input target T. Since values of P(x,y) are within the interval[0,1], then values of F(T,x,y) are also in the same interval[0,1]. Touch distribution functions represent information on how user selects input targets.

In one embodiment of the invention, the method/system may construct touch distribution functions for each target. In case of small targets, the touch distribution function for a target may be approximated as a sum of two independent normal distributions around the target origin. Parameters of these normal distributions are individual for every user and device, and can be obtained during interaction between user and device.

In one embodiment of the invention, if all targets have the same share and are relatively small compared to input object, the method/system may consider only one common touch distribution function for all targets and construct it based on all touch prints for all targets.

In one embodiment, the method/system may use a polar coordinate system (a,d) around target origin, where a is an angle, and d is a distance from point to the origin of a target. In another radial embodiment, the method/system of the invention may use only the distance between the origin and position within a touch print. That radial embodiment requires storing of only 1-dimensional touch distribution functions and therefore reduces memory requirements for the system.

In one embodiment of the disclosure, the target distribution function F(T) for each target object T may be represented as a discrete pixel table function for an individual user and a specific device, where the value of the distribution function F(T,dx,dy) for a target T is a sum of touch print functions P(dx,dy) in the position of the pixel (dx,dy) in relation to the origin O of the target. This function may be updated after each touch. After a number of touches values, the target distribution functions are adapting to individual user's way of selection of a target T.

In the general case, due the arbitrary selection of target origin and arbitrary shapes of the target and touch prints, the target distribution function may be asymmetrical, and its maximum may not coincide with the origin of the target. For example, the target distribution function for rectangular targets, like SPACE bar, may be elongated in one dimension. In another embodiment, the method/system may approximate target distribution functions by a composition of several normal distributions functions determined by coefficients of normal distributions.

The important stage of the touch processing is the initialization of target distribution functions, when no individual touch input information has been collected. In this case, for initial values, the method/system may use some average distribution functions, which were collected from a set of other users. Further, the method/system updated values of distribution functions using individual user touches.

During the process of data collection, different targets may be selected by user different number of times, for example, the letter “Z” at a virtual keyboard may be selected significantly less times, than the letter “E”, and the structure of corresponding target distribution functions in this case may be very different. To avoid this, the method/system may use a normalization coefficient for each target to scale values of distribution function to the same range.

In another embodiment, all distribution functions for all targets may be accumulated in one common target distribution function. In this embodiment, the method/system may store only one target distribution function. Values of this common target distribution function may be updated after every touch. In this case, the method/system doesn't need normalization coefficients and needs less memory to store positional distribution functions, but accuracy of target detection may be reduced, if targets have different shapes. This embodiment is well suited for a set of targets having near the same shapes and sizes, like keyboard keys or icons of menu.

### Touch Weights

To recognize what targets are close to a touch print and potentially were selected by a user during a touch, the method/system of the invention may calculate weights of input targets near the touch print. In one embodiment, the method/system may use the inverse distance between centers of a target and the touch print to determine touch weight of a target. So input targets, which are closer to the touch print, will have a greater touch weight.

In the general case, the method/system of the invention may calculate a touch weight of a target as an area integral of the product of touch print and target distribution functions in all positions. For discrete embodiments of the invention, the touch weight may be determined as a sum of products of these functions in all positions (x,y):

W(T,P)=SUM(F(T,x,y)*P(x,y)).

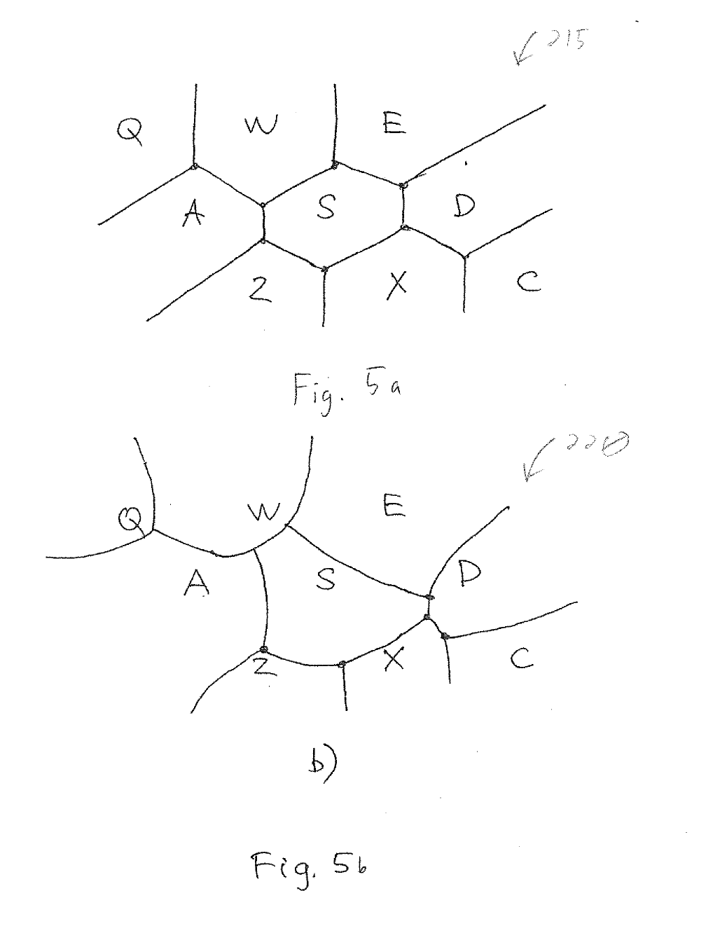

Touch weight of a target of the invention is a quantitative value, describing how similar a specific touch print is to all other touch prints, which the user made earlier to select some specific target. In cases where the touch print and target distribution functions don't intersect, the touch weight will be 0. The touch weight increases as the touch print and the target distribution function become closer. For example, touch weights of targets associated with letters “R”, “T”, “F” toward the touch 31 at FIG. 3 may be 0.1, 0.4, 0.6 correspondingly, but touch weights of targets “G” or “Y” are 0.

Touch weight is one of the characteristics of the disclosed method/system. In one embodiment, the method/system may select as the input, corresponding to a touch, the input value or values associated with the target with the maximal touch weight. In general case, in order to recognize the input sequence, the method/system analyzes all targets having non-zero touch weights for a sequence of touches.

For each touch, the method/system of the invention may provide a list of all targets with non-zero touch weights and corresponding input values in descending order of touch weights. This list of targets provides complete information about the touch: all possible input values and their weights. For example, target lists of touch prints 31, 32, 33 are shown in a diagram 206 of FIG. 3 and may be: {(r,0.6),(t,0.4),(f,0.1)}, {(g,0.7),(h,0.2),(y,0.05)}, {(w,0.5),(e,0.5),(s,0.3)}.

Therefore, differently to existing target recognition approaches based on artificial target function and regions, which are calculated and updated using some invented rules, the method/system of the invention utilizes whole native raw data about the user's way of targeting. Target distribution functions completely represent all available positional and contextual information about targeting and are the most natural way to describe process of touch input.

### Touch Weight of an Input Sequence

The method/system of touch recognition of the invention may determine possible input sequences corresponding to a sequence of touches. The method/system may assign touch weights to possible input sequences based on touch weights of targets associated with individual inputs comprising the sequence.

The touch weight of an input sequence is a product of touch weights of all targets associated with input values of the input sequence. In order to reduce the number of analyzed sequences, the method/system of the invention may process only sequences determined by target lists of touch prints.

For example, the sequence of three touches 31, 32, 33 shown at FIG. 3 and corresponding target lists may determine 9 different possible input sequences and their touch weights. Some of these possible input sequences, like “fgw” may have a high touch weights 0.6*0.7*0.5=0.21, but are not very common letter combinations in English. Other ones like “rye” and “the” are common English words, but may have lower touch weights 0.015 and 0.04 correspondingly, due non-precise selection of targets by a user.

To improve input recognition, the precognition method/system of the disclosure may use information about expectations of possible input sequences. At this step, the method/system of the invention may determine expectation weights of possible input sequences determined by target lists and continuation of these sequences. For example, for the sequence “the” determined by target lists, the method/system may consider all possible continuation from the expectation tree: “the_”, “they”, “they_”, etc.

In the general case, the input stream may be decomposed into 3 parts: the past, corresponding to input history before current touch input; the present, corresponding to the current touch input sequence determined by target lists and recognized by the system; and the future corresponding to the sequence predicted by the system.

### Combined Weight

Further, the recognition method/system of the invention may combine expectation and touch weights of all possible input sequences. The combined weight of an input sequence may be a product of expectation and target weight of this sequence.

The method/system of the disclosure may order all candidate input sequences by their combined weights. For example, for the sequence of touches in FIG. 3, the combined weight of the candidate input sequence “the_” may be greater then the expectation weight of “the” and any other candidate sequences, so the input sequence “the_” becomes the most weighted sequence and the default candidate.

Therefore, after this step, the precognition method/system of the invention may have a list of possible input sequences ordered by their combined weight, which is based on both history context and spatial proximity expectations of input sequences.

### Workflow of Input Precognition Process

The precognition method/system of the invention seamlessly combines recognition of current touch input sequence with prediction of future input sequences into one common precognition process. The general workflow of the input precognition process is shown in a flowchart 210 of FIG. 4.

At the beginning of each iteration of the precognition process, the method/system initializes the list of possible candidate sequences ordered by their expectation weights. At this stage, the list of candidate sequences is based purely at expectation weights, because no touch input has occurred yet.

At the next step, the list of candidate sequences may be presented to user and if the list contains the desired sequence, then a user may select it from the list. Also, one of sequences may be default and may be confirmed by a user. The user may confirm the default input in one of many ways: either by selecting the default input, or by entering some pre-assigned input value, for example, a SPACE or another non-letter symbol, or by continuing of input process. The user also may scroll the list of candidate sequences to find the desired sequence.

If the user selects a candidate input sequence from the list, then the method/system enters it, and updates the expectation tree by adding the selected input sequence. The method/system may also update touch distribution functions for all targets corresponding to individual touches of the selected input sequence. After this, the method/system starts a new iteration of the precognition process and returns to initialization stage.

If the user doesn't select any of candidate input sequences, then the method/system may continue the process of precognition of the current input and proceed to the recognition of the user touches. Based on analysis of target distribution functions and target lists, the method/system builds a list of possible candidate sequences and determines their touch weights.

At the next step, the method/system extends a list of possible candidate sequences, adding all possible continuations of existing candidate sequences in the expectation tree. The method/system calculates expectation and combined weights of candidate sequences, and orders all sequences by their combined weight. Afterwards, the method/system returns to the step of the selection of a sequence.

The precognition process of the disclosure combines both touch and linguistic information to reduce the set of candidate sequences. This combination provides the additional improvement of input recognition for touch interfaces. The precognition workflow is found in several embodiments of the invention.

### Weighted Functional Voronoi Diagrams

In this less complex embodiment, the method/system of the invention may be used for input recognition and prediction of only one next input symbol. In this embodiment, the method/system may use center-defined touch prints of the same shape and static target distribution functions. For such touch prints, their target weights are completely defined by the interposition of their centers toward targets.

Expectation and expectation weight of a next input symbol may be determined from the expectation tree using the approach described hereinabove. The method/system may generate the list of symbols ordered by their expectation weight.

To determine touch weights of a inputs, the method/system may pre-calculate and use further a static touch weight function F(T,x,y), which is equal to touch weight of a touch print with center in position (x,y) toward the center of target T.

In this embodiment, the method/system of the invention may construct the weighted functional Voronoi diagram for these distribution functions for recognition of input. The classic Voronoi diagram for a set of N generator points Pk consists of N cells, where each cell consisting of every point whose distance to Pk is less than or equal to its distance to any other point. FIG. 5a shows the classic Voronoi diagram 215 of a set of points representing centers of target keys of a part of a virtual keyboard. The classic Voronoi diagram corresponds to the case of equal expectations of all inputs.

In the general case, the method/system of invention may construct a weighted functional Voronoi diagram, determined by input expectations and touch weight functions. The method/system of the invention may consider expected touch weight functions C(T,x,y))=E(T)*F(T,x,y) of touch positions around input targets, therefore F(T,x,y) is the touch weight function for target T, and E(T) is the expectation of input value associated with target T. In this case, each Voronoi cell consisting of every point whose value of function C(T,x,y) is greater than or equal to value of the same functions for all other targets.

FIG. 5b shows the weighted functional Voronoi diagram 220 of a set of letters of a part of virtual keyboard, where expectation weights of targets are equal to frequencies of corresponding letter. Further, for given coordinates (x,y) of the center of touch print, the method/system may determine to which target and cell of Voronoi diagram this center belongs, and therefore recognizes the input value of the touch.

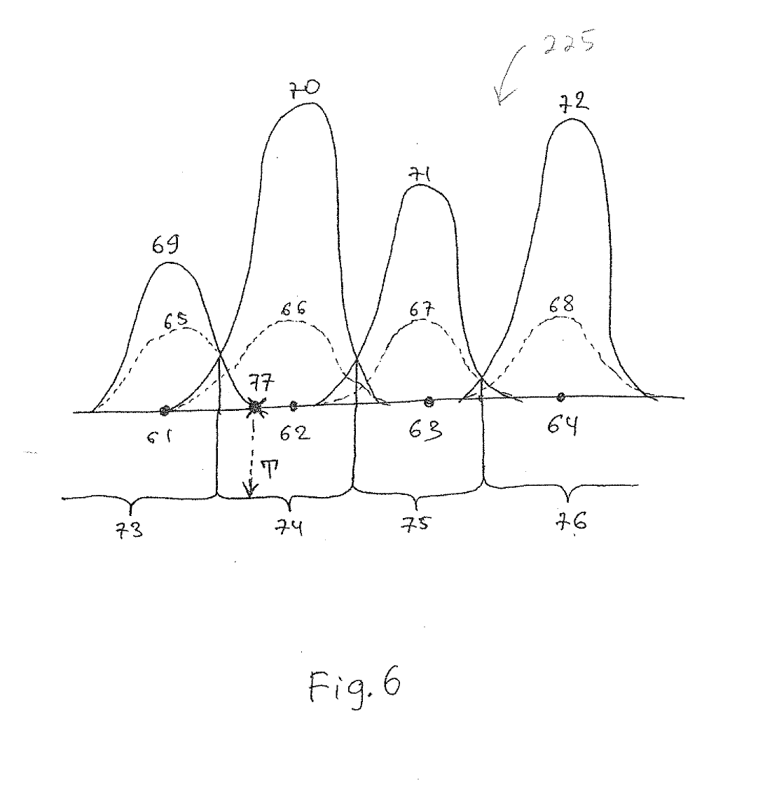

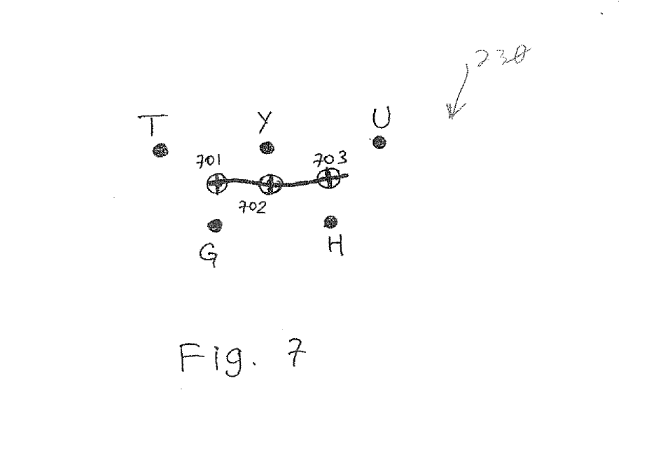

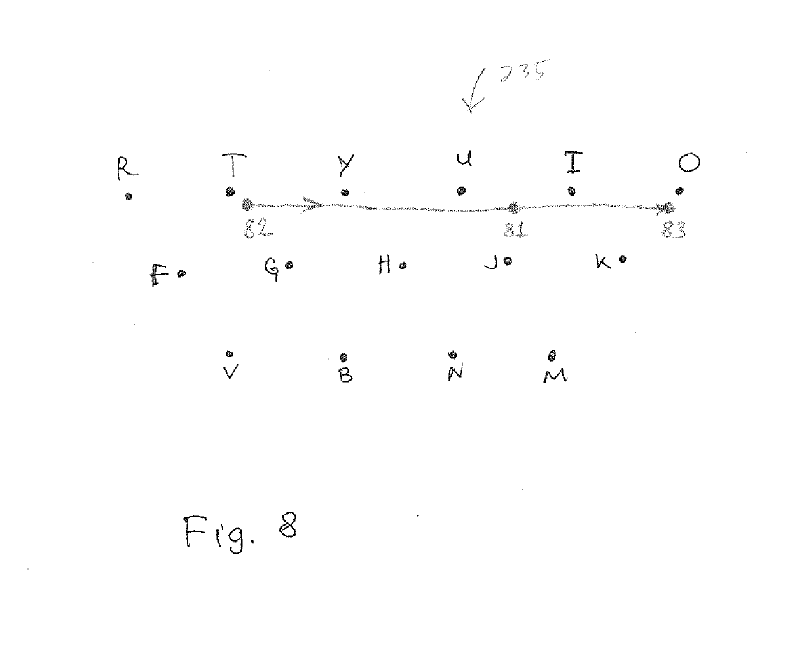

FIG. 6 includes a diagram 225, which shows the process of input recognition using a weighted Voronoi diagram for the set of one-dimensional targets Ti 61, 62, 63, 64. Values of functions of touch weight F(Ti) 65, 66, 67, 68 are multiplied to expectation weights E(Ti), correspondingly 1.5, 4, 2, 3. The resulting expected touch weight functions C(Ti)=E(Ti)*F(Ti) 69, 70, 71, 72 subdivide the interval into four Voronoi cells 73, 74, 75, 76. In each interval, the value of corresponding function C(Ti) is greater then values of expected target weight functions of other targets. After the user makes a touch T in position 77, the method/system determines what cell of Voronoi diagram contains this position. In the presented example, this is cell 74. The cell determines the selected target 62 and the input value associated with the target.

Actually, the method/system doesn't need to construct the whole weighted Voronoi diagram explicitly. In the embodiment described above, the method/system may calculate expectation and touch weights only for all close input targets and select the input target having the maximal combined value.

Such weighted functional Voronoi diagram may be used for improved input recognition of touch input. To determine the input value, the method/system may just determine in which cell of Voronoi diagram the center of touch print is located. The method/system may display Voronoi cells to a user or hide them. The method/system may use the area of cells as a parameter to represent input symbols. For example, a size or a color of a symbol may be determined by the area of its' Voronoi cell.

### Continuous Touch Input

In another embodiment of the invention, the touch input for a sequence may be represented by a 2D continuous trace at the input surface. A user may draw a trace connecting input targets corresponding to input values of an input sequence over the input surface without lifting an input object from the input surface. Existing approaches of continuous touch input are word based and require either an input of the trace corresponding to the whole word for recognition, or may auto complete a whole word, based on recognized input of the trace corresponding to several first letters of a word.

Different to existing approaches for continuous input, the input method/system of the invention may recognize and predict non-word-aligned input sequences of arbitrary length. The input method/system of the invention may utilize the partial spatial information about the trace to recognize and predict input sequences.

In order to create the list of candidate sequences, the method/system of the invention may use information from expectation tree for creation of a list of candidate sequences. Before the trace starts, this list is empty. After the start of a trace, the list of candidate sequences consists of input sequences corresponding to the initial position of the trace, determined as described above for tap input.

Further, for each displacement of the trace, the method/system may determine the new target list for the current position of the input object along the trace, and combine input values of this target list with all input sequences in the current list of candidates. Most of these combined sequences will have zero expectation. The method/system may store only sequences with non-zero expectation in the list of candidates. The method/system also updates target weights of input values already used at the previous step.

After processing of each displacement, the new input list comprises all sequences, which were there at the previous step and all new non-zero weight sequences, which are combination of existing sequences and inputs from the current target list. For example, for the trace shown in a diagram 230 of FIG. 7, the list of candidates at the first step in position 701 may consist of sequences “t”, “y”, “g”, and the target list in position 702 may consist of input values “t”, “g”, “h”. New combined sequences are “tt”, “tg”, “th”, “yt”, “yg”, “yh”, “gt”, “gg”, “gh”. Depending on input history, most of them will have zero expectation in the expectation tree. For example, only “th” and “gh” may have a non-zero expectation. Then, the initial candidate list after the step 702 may include three old sequences “t”, “y”, “g”, and two new ones “th” and “gh”. After 703, it may contain “t”, “y”, “g”, “th”, “gh” and new sequences “yu”, “tu”, “gu”, “thu”.

Further processing of candidate input sequences is the same as for tap input. The method/system calculates their combined weights and proceeds to the selection stage. A user may confirm selection of a candidate input sequence by lifting an input object from the input surface. If necessary, a user may select another word in a list of candidate sequences.

Different from existing swipe input approaches, the method/system of the invention predicts not a word, but an input sequence of an arbitrary length and prediction doesn't require input of a trace for a whole word. The precognition process starts even before the touch of the input surface and continues during the swipe input.

Different from existing swipe input approaches, the method/system of the invention may use just a part of the continuous trace between consecutive input targets for precognition of input sequence. For example, as shown in a diagram 235 of FIG. 8, the method/system of the invention may precognize the sequence “the_” just after the user touches the input surface at position 82 near the input target “T”, because the expectation for “the_” has a greatest combined weight amongst all traces started in this position. Further, after some horizontal displacement to right, the method/system may switch to the sequence “to_” after position 81, because potential combined weight of “to_” becomes greater then combined weight of “the_”. In both cases, the method/system of the invention doesn't require that the swipe crosses target areas of next letters “h” or “o”, but precognizes user intention to move input object in directions to these target areas. The precognition method/system of the invention provides an input prediction at earlier stages of input comparing to any existing swipe processing approaches.

### Surface Clicks

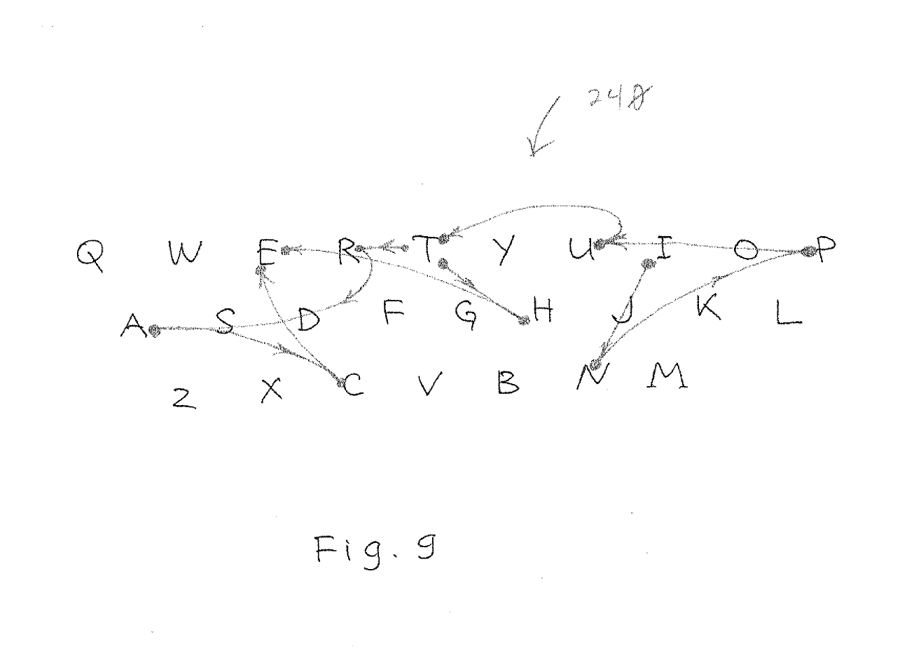

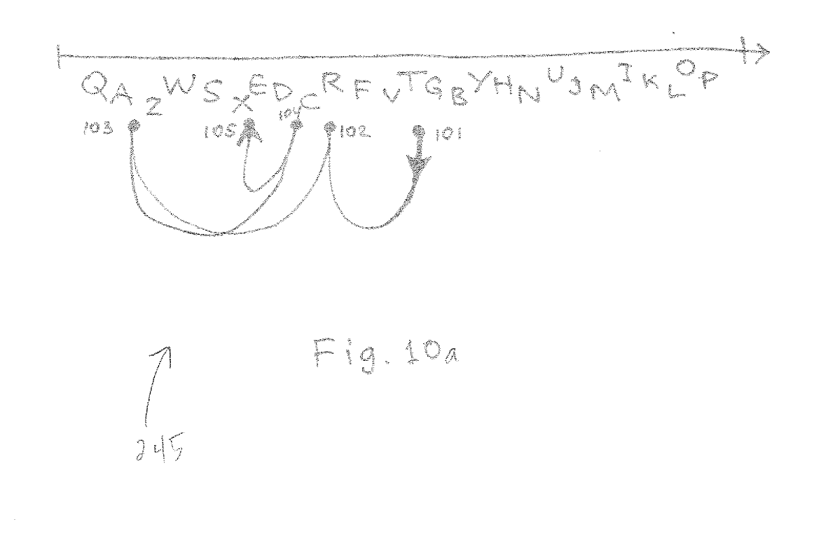

In order to simplify processing algorithms and radically reduce the number of candidate sequences, one embodiment of the input method/system of the invention may recognize “surface clicks”—sharp turns of the continuous trace at the input surface for selection of input targets. In this embodiment, the user may draw a continuous trace connecting consecutive input targets and make sharp turns of a trace near each input target. FIG. 9 includes a diagram 240, which shows possible continuous traces with surface clicks for input sequences “the”, “input” and “trace”. As it may be noticed from the drawing, most of surface clicks are natural for continuous traces connecting letters of these sequences. Artificial surface clicks are entered only near letters “R” and “U” at the FIG. 9.

The continuous input with surface clicks may be considered as a generalization of convenient touch tap input. Each tap or click of convenient tap input may be considered as a vertical sharp turn of a 3D trajectory of an input object near input target at the input surface. The method/system of the invention additionally recognizes sharp turns in all other directions at the input surface.

The method/system of the invention may recognize and interpret initial and final positions, and may position of surface clicks as centers of touch prints. The coordinates of clicks may be further processed by the method/system of the invention in the same way, as it was described above for processing of touch prints of conventional touch taps input. Therefore, the method/system of the invention may recognize and predict input sequences entered by continuous traces with surface clicks in positions of input targets.

The beneficial property of this embodiment is that the method/system may ignore all intermediate input targets intersecting with the input trace between input targets corresponding to surface clicks. This radically reduces the number of possible candidate input sequences and improves usability of the method/system.

The complexity of the detection of surface clicks is very low and this input doesn't require linguistic analysis for selection of input values. This provides a possibility of implementation of this method/system of continuous touch input in hardware in language-independent manner. The method/system may use a keyboard with a flat, keyless surface, reducing production costs. Such flat keyboard may be imbedded into a cover, a folio, and a case of a mobile device.

This embodiment of the invention also provides recognition of arbitrary mix of tap touches and continuous swipes with clicks. The user may switch between tap and continuous traces methods of input, and enter part of an input by touches, but another part by swipes with clicks. This is very beneficial property of the method of continuous input with surface clicks of the invention.

### Interface Applications

The method/system of the invention may be used in different interfaces based on touch selections. One of the disclosed embodiments of the invention is for virtual keyboards and keypads, in which keys are represented by a regular grid of target points. To improve target recognition, the distance between close input targets should be as maximal as possible. The embodiment of such optimal keyboard, based on the method/system of optimal point spreading within a container of a given shape is described in co-pending U.S. patent application Ser. No. 14/261,999, filed Apr. 25, 2014, titled “LATTICE KEYBOARDS WITH RELATED DEVICES”, assigned to the present application's assignee. The method/system of the present invention may be fully applied to optimal keyboards disclosed in the U.S. patent application Ser. No. 14/261,999.

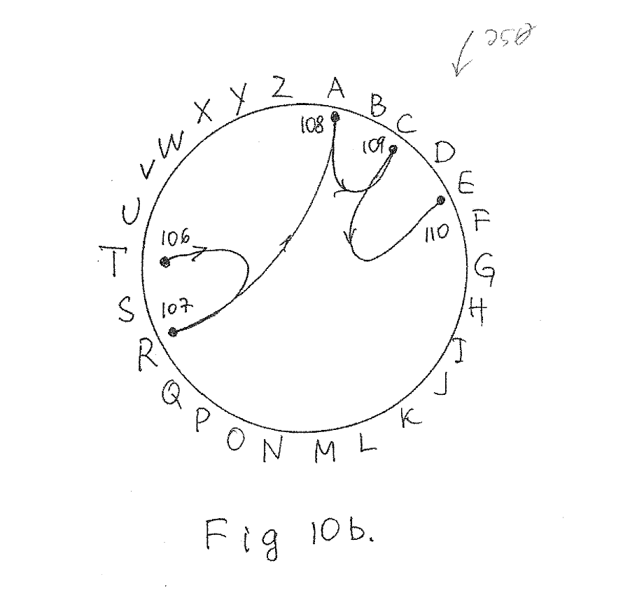

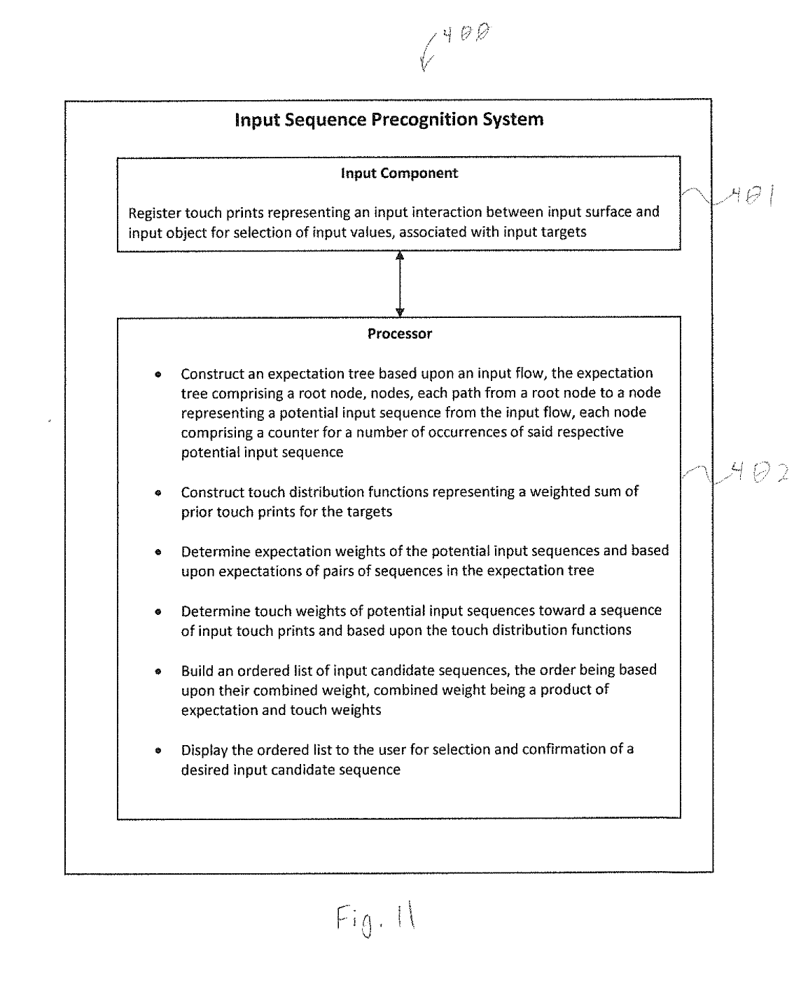

Another embodiment of the touch interfaces of the invention includes different one-dimensional linear or circular selection lists and menus. FIG. 10a includes a diagram 245, which shows an example of one-dimensional linear input interface of the invention utilizing continuous traces with surface clicks for selection of targets. The trace with surface clicks in positions 101-105 represent the input of the word “trace”. FIG. 10b includes a diagram 250, which shows an example of one-dimensional circular interface of the invention utilizing continuous traces with surface clicks for selection of targets. The trace with surface clicks in positions 106-110 represent the input of the word “trace”.

Another embodiment uses two dimensional touch interfaces, i.e. tables, grids of target objects or icons. In the general case, the touch interface of the invention may be represented by irregular spatial set of input of arbitrary shapes and dimensions. The embodiment of such interface is a web page with a set of selectable objects. The method/system of the invention may be efficiently applied to such web interfaces. The method/system may construct the distribution function for every selectable input target object, collecting positional information about touches from different users. Expectations of input target objects may be calculated based on statistics of selection of target objects and user history at the web site or page. The method/system of the invention may combine together positional and contextual statistical information about target objects at the web pages to improve the usability of web interfaces.

### Input Correction

The method/system of the invention also may be used for input correction. If there are no good candidates after recognition of the user touch input or if the user doesn't select any input sequence in a list, then the method/system of the invention may request user permission for correction of some typical input errors: wrong letters, missing letters, extra letters and letter order.

In order to do this, the method/system of the invention may generate artificial sequences, based on current list of candidate sequences. These artificial candidate sequences may include new sequences, which have some inputs values changed, added or removed to increase the combined weight of new corrected sequences. The user may select a corrected sequence from a list of corrected sequences.

### Partial Candidate Acceptance

To improve the selection of the candidate sequence further, the method/system of the invention may display the default candidate sequence in the input field and the user may accept just a part of the sequence by selection of the first incorrect input value in the sequence. For example, the method/system may display a candidate sequence “see you later”, but user may accept only a part “see you” by pointing the letter “L” in the word “later”. After this, method/system enters the accepted part before this letter updates predictions as described above in the method workflow, and the user may continue the sequence by other word, for example “soon”.

### Data Compression

Since the expectation tree is similar to a LZW tree, it is very natural to use it for input compression, or more generally for generic data compression. The method/system of data compression of the invention may use expectation values stored in the expectation tree for prediction of data sequences in a compressed data flow. The method/system of the invention may use the candidate sequences with highest expectation weight as the predicted data sequences. The method/system of the invention may transmit “1” bit, if the prediction is correct, and “0” bit otherwise. In the first case, the “1” may be followed by the index of a candidate sequence, if the method/system provides more then one candidate. In the second case, the method/system of the invention may transmit the index of the longest sequence from the root to the leaf of the expectation tree and a new input, as for LZW trees.

The method/system of the invention may use input data compression for the storage of input history in form of expectation trees constructed upon input streams. The method/system of the disclosure may use compression for storage of the input history between sessions and for transmission to any other system or application. Actually, the method/system of disclosure is so powerful that it may reconstruct the whole user input history from the stored expectation tree of LZW structure, so the method/system may be additionally configured to prevent this by restructuring of the expectation tree to increase the security of the system.

The method/system of the compression of the invention may also be used for compression of texts, images, video, sound, and, in general, of data streams of an arbitrary nature. Data compression with expectation of the invention provides better compression ratio comparing to the LZW algorithm, due to more optimal transmission of repeating sequences.

Referring now to FIG. 11, a system 400 according to the present invention is now described. The system 400 of input sequence precognition comprising an input component 401 configured to register touch prints representing an input interaction between input surface and input object for selection of input values, associated with a plurality of input targets, and a processor 402 coupled to the input component. The processor 402 may be configured to construct an expectation tree based upon an input flow, the expectation tree comprising a root node, a plurality of nodes. Each path from a root node to a node represents a potential input sequence from the input flow, and each node comprises a counter for a number of occurrences of the respective potential input sequence. The processor 402 may be configured to construct touch distribution functions representing a weighted sum of prior touch prints for the plurality of targets, and determine expectation weights of the potential input sequences and based upon expectations of pairs of sequences in the expectation tree. The processor 402 may be configured to touch weights of potential input sequences toward a sequence of input touch prints and based upon the touch distribution functions, build an ordered list of input candidate sequences, the order being based upon their combined weight, wherein combined weight is a product of expectation and touch weights, and display the ordered list to the user for selection and confirmation of a desired input candidate sequence.

Additionally, the input interaction may comprise a plurality of touch taps of input targets at the input surface, corresponding to the input sequence. The input interaction may comprise a continuous input trace connecting input targets at the input surface, corresponding to the input sequence. The processor 402 may be configured to recognize partial traces between consecutive targets for input target recognition. The processor 402 may be configured to recognize positions of sharp directional turns of the continuous input trace at the input surface as positions of touch input interaction.

Also, the processor 402 may be configured to add accepted input candidate sequences from the input flow to the expectation tree by adding a new node and respective path to the expectation tree. The processor 402 may be configured to add consecutive, non-overlapping accepted candidate sequences from the input flow to the expectation tree. The processor 402 may be configured to add accepted candidate sequences starting at every input value from the input flow to the expectation tree. The expectation weight of a respective potential input sequence may be a value measuring a number of potentially saved inputs if a predicted sequence is correct.

The expectation weight of the respective potential input sequence may be a product of maximal expectation of the respective potential input sequence after all possible previous sequences in a current input flow and a length of the respective potential input sequence. The touch weight of the respective potential input sequence may comprise a value measuring a spatial proximity of an input trace and expected input trace for the respective potential input sequence. The touch weight of the respective potential input sequence may be a product of touch weights of input targets corresponding to inputs of the input sequence, and the touch weight of a target may be an integral of the product of touch print and target distribution function.

In some embodiments, the input candidate sequences may be word aligned and comprise at least one word. The input candidate sequences may comprise sequences of input values of an arbitrary length. The input candidate sequences may be limited to one letter, and the plurality of input targets may have a common centered distribution function. The input precognition may be determined by cells of a functional Voronoi diagram for target distribution functions, weighted by expectation weights of inputs, assigned to the plurality of input targets.

A default candidate sequence may comprise a candidate sequence with a greatest combined weight, and may be displayed in an input field of an application, and the user may confirm input of any part of the default candidate sequence. The processor 402 may be configured to detect and correct misprinted candidate sequences upon user request. The processor 402 may be configured to expand a predicted sequence inductively, using a predicted sequence for prediction of a new sequence at a subsequent stage. The processor 402 may be configured to use the expectation tree for data compression with prediction of the input flow for storing of input history between sessions and transmission to another system.

For example, the plurality of input targets may comprise keys of a keyboard. The plurality of input targets may comprise objects of a 2-dimensional input interface. The plurality of input targets may comprise objects of 1-dimensional input interface.

Another aspect is directed to a method of input sequence precognition. The method may include operating an input component 401 to register touch prints representing an input interaction between input surface and input object for selection of input values, associated with a plurality of input targets, and operating a processor 402 coupled to the input component. The processor 402 may construct an expectation tree based upon an input flow, the expectation tree comprising a root node, a plurality of nodes. Each path from a root node to a node represents a potential input sequence from the input flow, and each node comprises a counter for a number of occurrences of the respective potential input sequence. The processor 402 may construct touch distribution functions representing a weighted sum of prior touch prints for the plurality of targets, and determine expectation weights of the potential input sequences and based upon expectations of pairs of sequences in the expectation tree. The processor 402 may determine touch weights of potential input sequences toward a sequence of input touch prints and based upon the touch distribution functions, build an ordered list of input candidate sequences, the order being based upon their combined weight, wherein combined weight is a product of expectation and touch weights, and display the ordered list to the user for selection and confirmation of a desired input candidate sequence.

One of ordinary skill in the art will recognize that the present embodiments may be incorporated into hardware and software systems and devices for input prediction and recognition. These devices or systems generally may include a computer system including one or more processors that are capable of operating under software control to provide the input method of the present disclosure.

Computer program instructions may be loaded onto a computer or other programmable apparatus to produce a machine, such that the instructions, which execute on the computer or other programmable apparatus together with associated hardware creation means for implementing the functions of the present disclosure. These computer program instructions may also be stored in a computer-readable memory that can direct a computer or other programmable apparatus to function in a particular manner, such that the instructions stored in the computer-readable memory together with associated hardware produce an article of manufacture including instruction means which implement the functions of the present disclosure. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the present disclosure. It will also be understood that functions of the present disclosure can be implemented by special purpose hardware-based computer systems, which perform the specified functions or steps, or combinations of special purpose hardware and computer instructions.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A system of input sequence prediction and recognition, the system comprising:
an input component configured to register touch prints representing an input interaction between input surface and input object for selection of input values, associated with a plurality of input targets; and
a processor coupled to said input component and configured to
construct an expectation tree based upon an input flow, the expectation tree comprising a root node, a plurality of nodes, wherein each path from a root node to a node represents a potential input sequence from the input flow, and wherein each node comprises a counter for a number of occurrences of said respective potential input sequence,
construct touch distribution functions representing a weighted sum of prior touch prints for the plurality of targets,
determine expectation weights of the potential input sequences and based upon expectations of pairs of sequences in the expectation tree,
determine touch weights of potential input sequences toward a sequence of input touch prints and based upon the touch distribution functions,
build an ordered list of input candidate sequences, the order being based upon their combined weight, wherein combined weight is a product of expectation and touch weights, and
display the ordered list to the user for selection and confirmation of a desired input candidate sequence.

2. The system of claim 1 wherein the input interaction comprises a plurality of touch taps of input targets at the input surface, corresponding to the input sequence.

3. The system of claim 1 wherein the input interaction comprises a continuous input trace connecting input targets at the input surface, corresponding to the input sequence.

4. The system of claim 3 wherein said processor is configured to recognize partial traces between consecutive targets for input target recognition.

5. The system of claim 3 wherein said processor is configured to recognize positions of sharp directional turns of the continuous input trace at the input surface as positions of touch input interaction.

6. The system of claim 1 wherein said processor is configured to add accepted input candidate sequences from the input flow to the expectation tree by adding a new leaf node and respective path to the expectation tree.

7. The system of claim 6 wherein said processor is configured to add consecutive, non-overlapping accepted candidate sequences from the input flow to the expectation tree.

8. The system of claim 6 wherein said processor is configured to add accepted candidate sequences starting at every input value from the input flow to the expectation tree.

9. The system of claim 1 wherein the expectation weight of a respective potential input sequence is a value measuring a number of potentially saved inputs if a predicted sequence is correct.

10. The system of claim 9 wherein the expectation Weight of the respective potential input sequence is a product of maximal expectation of the respective potential input sequence after all possible previous sequences in a current input flow and a length of the respective potential input sequence.

11. The system of claim 1 wherein the touch weight of the respective potential input sequence comprises a value measuring a spatial proximity of an input trace and expected input trace for the respective potential input sequence.

12. The system of claim 11 wherein the touch weight of the respective potential input sequence is a product of touch weights of input targets corresponding to inputs of said input sequence; and wherein the touch weight of a target is an integral of the product of touch print and target distribution function.

13. The system of claim 1 wherein the input candidate sequences are word aligned and comprise at least one word.

14. The system of claim 1 wherein the input candidate sequences comprise sequences of input values of an arbitrary length.

15. The system of claim 1 wherein the input candidate sequences are limited to one letter; wherein the plurality of input targets has a common centered distribution function; and wherein input precognition is determined by cells of a functional Voronoi diagram for target distribution functions, weighted by expectation weights of inputs, assigned to the plurality of input targets.

16. The system of claim 1 wherein a default candidate sequence comprising a candidate sequence with a greatest combined weight, is displayed in an input field of an application; and wherein the user confirms input of any part of the default candidate sequence.

17. The system of claim 1 wherein said processor is configured to detect and correct misprinted candidate sequences upon user request.

18. The system of claim 1 wherein said processor is configured to expand a predicted sequence inductively, using a predicted sequence for prediction of a new sequence at a subsequent stage.

19. The system of claim 1 wherein said processor is configured to use the expectation tree for data compression with prediction of the input flow for storing of input history between sessions and transmission to another system.

20. The system of claim 1 wherein the plurality of input targets comprises regions of arbitrary shape at the input surface.

21. The system of claim 1 wherein the plurality of input targets comprises keys of a keyboard.

22. The system of claim 1 wherein the plurality of input targets comprises objects of a 2-dimensional input interface.

23. The system of claim 1 wherein the plurality of input targets comprises objects of 1-dimensional input interface.

24. A method of input sequence prediction and recognition comprising:
operating an input component to register touch prints representing an input interaction between input surface and input object for selection of input values, associated with a plurality of input targets; and
operating a processor coupled to the input component and to
construct an expectation tree based upon an input flow, the expectation tree comprising a root node, a plurality of nodes, wherein each path from a root node to a node represents a potential input sequence from the input flow, and wherein each node comprises a counter for a number of occurrences of the respective potential input sequence,
construct touch distribution functions representing a weighted sum of prior touch prints for the plurality of targets,
determine expectation weights of the potential input sequences and based upon expectations of pairs of sequences in the expectation tree,
determine touch weights of potential input sequences toward a sequence of input touch prints and based upon the touch distribution functions,
build an ordered list of input candidate sequences, the order being based upon their combined weight, wherein combined weight is a product of expectation and touch weights, and
display the ordered list to the user for selection and confirmation of a desired input candidate sequence.

25. The method of claim 24 wherein the input interaction comprises a plurality of touch taps of input targets at the input surface, corresponding to the input sequence.

26. The method of claim 24 wherein the input interaction comprises a continuous input trace connecting input targets at the input surface, corresponding to the input sequence.

27. The method of claim 26 further comprising operating the processor to recognize positions of sharp directional turns of the continuous input trace at the input surface as positions of touch input interaction.

28. The method of claim 24 further comprising operating the processor to add accepted input candidate sequences from the input flow to the expectation tree by adding a new leaf node and respective path to the expectation tree.

29. The method of claim 24 wherein the expectation weight of a respective potential input sequence is a value measuring a number of potentially saved inputs if a predicted sequence is correct.

30. The method of claim 24 wherein the touch weight of the respective potential input sequence comprises a value measuring a spatial proximity of an input trace and expected input trace for the respective potential input sequence.

31. The method of claim 24 wherein the input candidate sequences comprise sequences of input values of an arbitrary length.

32. The method of claim 24 wherein a default candidate sequence comprising a candidate sequence with a greatest combined weight, is displayed in an input field of an application; and wherein the user confirms input of any part of the default candidate sequence.

33. The method of claim 24 wherein the plurality input targets comprises keys of a keyboard.
